(19) United States
(12) Patent Application Publication
(10) Pub. No.: US 2017/0195535 A1
(43) Pub. Date: Jul. 6, 2017

(54) Flashgun for use with mobile devices

(71) Applicant: Murray William Schofield, Horsham (GB)

(72) Inventor: Murray William Schofield, Horsham (GB)

(21) Appl. No.: 15/372,425

(22) Filed: Dec. 8, 2016

(30) Foreign Application Priority Data
Dec. 18, 2015 (GB) GB1522455.3
Jun. 24, 2016 (GB) GB1611018.1

(51) Int. Cl. H04N 5/225; G03B 17/56; H04N 5/232; G03B 15/05; G08C 17/02; H04B 1/3888

(52) U.S. Cl. CPC H04N 5/2256; G08C 17/02; H04B 1/3888; H04N 5/23206; G03B 15/05; G03B 17/566; H04N 5/23216; H04N 5/23245

(57) ABSTRACT

The invention provides a remote flashgun incorporating a xenon flash bulb for use with a mobile device comprising an internal camera that enables the user to take improved photographs in low light conditions. A plastic case is used to hold the flashgun and mobile device in close proximity. An application running on the mobile device communicates with the flashgun to provide information on the required total flash light output and timing to synchronize with the mobile device capturing an image or photograph.

The invention further enables the user to take photographs of high speed events, such as a balloon bursting. The flashgun is configured with an integrated microphone to provide a trigger signal to operate the xenon bulb at a time suitable to illuminate the high speed event. The application operates the camera to take continuous images and captures the image when the flash bulb was operated.

This application claims priority under 35 U.S.C. §119(a) of Great Britain Application No. GB 1611018.1, filed Jun. 24, 2018 which claims further priority to Great Britain Application No. GB 1522455.3, filed on Dec. 18, 2015, the entire content of which is incorporated herein by reference.

### TECHNICAL FIELD OF THE INVENTION

The invention relates to a flashgun for a mobile device and a case to hold the flashgun and mobile device in close proximity.

### BACKGROUND OF THE INVENTION

Mobile devices such as smartphones and tablets generally comprise an internal camera and an integral light emitting diode, LED, flash light on the device to improve the illumination of a subject when taking a photograph of the subject. LEDs have a very limited brightness which can affect the sharpness and quality of an image taken in low light conditions.

Mobile devices are often fitted with a protective case to reduce the possibility of damage in use. To increase the range of photographs that may be taken it is known to mount an additional lens in front of the camera on the mobile device.

One particular area of photography, known as high speed photography, is concerned with capturing photographs, or images of fast moving subjects, such as a balloon bursting. This requires complex equipment such as a camera with manual settings, an external flashgun and a trigger system coupled with a sensor. The photography setup is typically arranged in black out conditions with the camera shutter open. It requires a great deal of expertise to create and use such a setup. Mobile devices are not suited for taking such pictures.

It is an object of the present invention to overcome these issues.

### SUMMARY OF THE INVENTION

In a first aspect, the invention provides a flashgun for use with a mobile device comprising an internal camera; said flashgun comprising: at least one xenon flash bulb operable to illuminate a subject to be photographed; and a radio control system configured to receive a radio control signal from the mobile device for remote control of the flashgun, the signal including at least the total flash light output required from the flashgun to photograph the subject, the control system configured to operate the flashgun with the total flash light output required from the flash bulb based upon said received radio control signal.

By providing such a remote flashgun incorporating a xenon flash bulb for use with a mobile device comprising an internal camera the user is able to take improved photographs in low light conditions.

In a second aspect the present invention provides an application for running on a mobile device comprising an internal camera said application configured to send a radio control signal to the flashgun according to any preceding claim, the signal comprising at least the total flash light output required from the flashgun to photograph the subject. The application running on the mobile device communicates with the flashgun to provide information on the required total flash light output and timing to synchronize with the mobile device in capturing an image or photograph.

The application, running on the mobile device is used to adjust the sensitivity and delay of a microphone and trigger device. The sensitivity of the trigger device is related to the volume, or change in volume, of an audio event picked up by the microphone that is required to cause the trigger device to activate. The delay is the period of time between the microphone sensing an audio event and the trigger device activating. The application operates the camera to take continuous images and captures the image when the flash bulb was operated. By using the camera to take continuous images the user is free to take as long as they need to set up the photograph, and they do not have to work in near blackout conditions.

In a further aspect the present invention enables the user to take photographs of high speed events, such as a balloon bursting. The flashgun is configured with an integrated microphone to provide a trigger signal to operate the xenon bulb at a time suitable to illuminate the high speed event.

In a further aspect, the invention provides a protective case made from a flexible plastic material, wherein the case maybe releasably attached to the flashgun and to the mobile device comprising an internal camera, holding the flashgun and mobile device in close proximity and allowing the user to conveniently carry the flashgun together with the mobile device and take improved photographs in low light conditions.

In a further aspect of the invention the case is configured to releasably attach a lens in front of the camera of the mobile device to change the field of view. For example: a wide angle or telephoto or close up lens maybe used to give the required image.

The lens may be attached by any known method such as a screw fitting, push fitting, bayonet fitting or magnetic coupling.

A button on the flashgun is configured to enable a user to command the mobile device to take a photograph and operate the flashgun via the radio communication.

Other preferred and/or optional aspects of the invention are defined in the accompanying claims.

### BRIEF DESCRIPTION OF THE DRAWINGS

In order that the present invention may be well understood, embodiments thereof, which are given by way of example only, will now be described with reference to the accompanying drawings, in which:

FIG. 1 is an illustration and schematic of the flashgun with an integrated microphone and a typical mobile device 1 with an integrated camera 2

FIG. 2 is an illustration of the case 10 with the flashgun 3 and a typical mobile device with an integrated camera 2

FIG. 3 is an illustration of the case 10 with the flashgun 3 and mobile device 1 removed.

FIG. 4 is an illustration of the case 10 with a lens 15 fitted over the camera 2.

### DETAILED DESCRIPTION OF THE INVENTION

FIG. 1 is an illustration and schematic of the flashgun according to the present invention. The flashgun 3 comprises a flashgun radio control system 6, 7 comprising a controller 6 and radio control system transmitter/receiver 7 and a battery, not shown. The controller 6 is connected to a xenon flash bulb 4 and to a microphone 5 for receiving data and control thereof. The controller 6 comprises a microprocessor and associated circuitry.

The figure also shows a typical mobile device 1 with an integrated camera 2.

The invention provides a remote flashgun 3 incorporating a xenon flash bulb 4 for use with a mobile device 1 comprising an internal camera 2 that enables the user to take improved photographs in low light conditions.

The flashgun 3 uses a xenon flash bulb 4 to provide a high brightness or high total flash light output, in a very short time. Typically less than 0.001 of a second. The advantage of a snort flash time is that any motion within the photograph appears to be frozen or still and the photograph has a sharp quality with no blur caused by movement.

The flashgun 3 is in communication with the mobile device through a radio control system 6, 7 configured to receive a radio control signal from the mobile device for remote control of the flashgun. The mobile device 1 communicates a signal, to the radio control system 7, comprising the total flash light output required from the flashgun 3 to photograph the subject.

The radio control system in the flashgun 3 is configured to operate the flashgun 3 with the total flash light output required from the flash bulb based upon said received radio control signal. The mobile device 1 is further configured to communicate a signal the flashgun radio control system 8, 7 to operate the flash bulb 4 at a specific time in order to synchronize the operation of the flash bulb with the operation of the camera on the mobile device.

The radio control system 6, 7 uses a radio transmitter 7 in each of the mobile device and the flashgun and a radio receiver 7 in each of the mobile device and the flashgun to communicate the required signals between devices.

This enables signals to be transmitted from the mobile device 1 to the flashgun 3 and from the flashgun 3 to the mobile device 1.

The radio control system 6, 7 can use any Known communication channels for example Bluetooth, Wireless (Wi-Fi).

An application running on the mobile device 1 is configured to control both the flashgun 3 and the camera 2 on the mobile device 1. The application provides a user interface on the mobile device screen with a range of controls.

In use, to take a photograph in low light conditions the application is configured to first communicate a signal the flashgun radio control system 6, 7 to operate the flash bulb at a low total flash light output. This is known as a first, pre flash operational mode. The application monitors the light level recorded by the camera 2 and determines the total flash light output required for a correctly exposed a photograph of a subject. The application then instructs the mobile device to communicate a signal to the flashgun radio control system 6, 7 to operate the flash bulb 4 in a second, operational mode at the required total flash light output and in synchronization with the camera shutter to take a photograph using the camera in the mobile device.

To take a photograph of a high speed event, such as a bursting balloon, the flashgun 3 is configured with an integral microphone 5. The microphone 5 is used to detect an audible event, coming from the high speed event. The flashgun radio control system includes a trigger device (not shown) and uses information from the microphone 5 to trigger operation of the Hash bulb 4 at a time suitable to illuminate the high speed event.

The application running on the mobile device 1 operates the camera 2 to capture at least one image when the flash bulb 4 was operated. This is achieved by the application operating the camera 2 to take repeated images, or a plurality of images and the application is able to identify when the flash bulb 4 was operated by monitoring the brightness of each image. By seeking at least one brightness increase from one image to the next, or over several images, the image, or images, in which the flash bulb 4 was operated are detected and saved.

The application running on the mobile device 1 operates the camera 2 to capture at least one image when the flash bulb 4 was operated. This maybe further achieved by the application operating the camera 2 to take repeated images and the flashgun 3 sending a signal to the mobile device 1 when the flash bulb 4 is triggered to operate. The application then saves the image that was recorded by the camera 2 at the time the flash bulb 4 was operated.

The method of taking repeated images allows a shutter speed of between 1/20 of a second and ½ of a second, preferably about ⅛ of a second. Having a shutter speed in this range is an advantage because the photograph can be taken in low ambient light conditions. Traditionally, complete darkness is required in high speed photography setups where the camera shutter is held open for several seconds Complete darkness makes it difficult to operate the photography set up.

The application running on the mobile device 1 enables the user to manually adjust the total flash light output required from the flashgun 3. The application communicates the required total flash light output to the flashgun radio control system 6,7.

The application running on a mobile device 1 is configured to send a radio signal to the radio signal control system 6,7 in the flashgun comprising information to adjust, the sensitivity and delay of the trigger device. The user can adjust the sensitivity using the application. The user may also adjust the delay, or period of time between the microphone 5 detecting an audible event and the flash bulb 4 being operated. This enables photographs to be taken to show for example the beginning of a balloon bursting or the final stages of a balloon bursting.

The application running on the mobile device 1 may also use any of the occurrence sensors within the mobile device to provide a trigger signal which can be signaled to the flashgun 3 to operate the flash bulb 4. For example movement sensors can detect if the mobile device is moved, or the camera 2 can detect if light levels change, if for example an object passes between a light source and the camera. A microphone (not shown) within the mobile device may also be used to detect an audible event and provide a trigger signal. Using an occurrence sensor on the mobile device, such as a microphone, requires that the mobile device communicates the trigger signal to the flashgun 3 to operate the flash bulb 4. This can introduce a significant delay, typically 0.05 seconds, which can be too long for some photographic applications.

Further processing to improve the high speed image is possible using the processing capability on the mobile device, for example sharpening, white balance improvement or contrast adjustment.

The application on the mobile device may guide the user through taking a photograph with instructions.

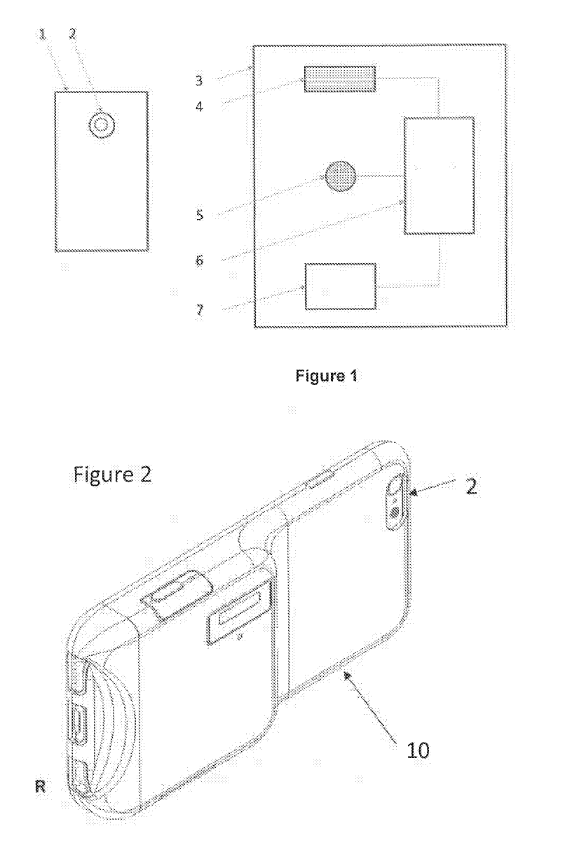

FIG. 2 is an illustration of the case according to the present invention. The case 10 fits onto a mobile device 1 in a conventional known method, either by stretching the case over the mobile device or by opening the case and fitting the mobile device within the case. The case 10 locates the flashgun 3 and holds it in close proximity to the mobile device 1.

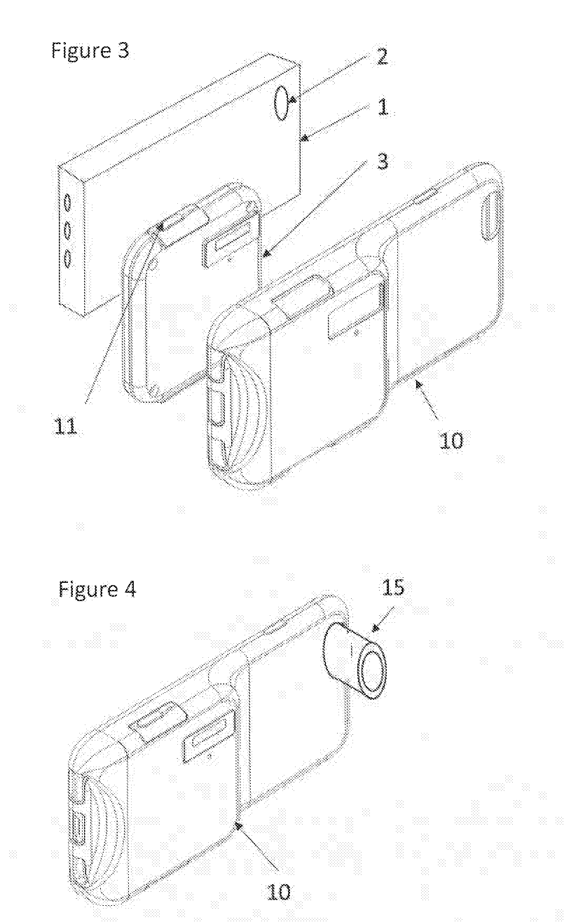

FIG. 3 shows the flashgun 3 and mobile device 1 removed from the case. A button 11 on the flashgun 3 is configured to enable a user to command the mobile device 1 to take a photograph and operate the flashgun 3 via the radio communication link.

FIG. 4 shows that the case 10 provided with the capability to attach a lens 15 in front of the camera to change the field of view. For example: a wide angle or telephoto or close up lens maybe used to give the required image. The lens may be fitted to the case by any know means, for example a magnetic element, a bayonet fitting, a screw thread or push fit. Not shown.

The flashgun 3 maybe removable from the case lo enable a user to hold the flashgun remote from the camera to give a different lighting effect, such as lighting the subject to be photographed from one side.

1. A flashgun for use with a mobile with an internal camera comprising:
at least one xenon flash bulb operable to illuminate a subject to be photographed; and
a radio control system configured to receive a radio control signal from the mobile device for remote control of the flashgun, the signal including at least the total flash light output required from the flashgun to photograph the subject, the control system configured to operate the flashgun with the total flash light output required from the bulb based upon said received radio control signal.

2. The flashgun of claim 1 wherein the radio control system is configured to operate the flash for a first, pre-flash, operational mode for illuminating the subject to be photographed sufficiently for the mobile device to operate its internal camera and obtain information required to determine the total flash light output required for photographing the subject during a second operational mode.

3. The flashgun of claim 1 further comprising an integral microphone.

4. The flashgun of claim 1, further comprising a trigger device configured to operate the flash bulb upon detection of an audible event by the microphone.

5. The flashgun of claim 1 further comprising a button configured to
enable the user to command the mobile device to lake a photograph and operate the flashgun via the radio communication link.

6. The flashgun of claim 1 wherein a protective case is made from a flexible plastic material, and is releasably attached to the flashgun and mobile device haying an internal camera to hold the flashgun in close proximity to the mobile device.

7. The flashgun of claim 6 wherein the protective case is configured to support a lens in front of the camera of the mobile device.

8. The flashgun of claim 1 further comprising an application for running on a mobile device with an internal camera, wherein the application is configured to send a radio control signal to the flashgun and the signal includes at least the total flash light output required from the flashgun to photograph the subject.

9. The flashgun of claim 8, wherein the application is further configured to enable the user to adjust the total flash light output required from the flashgun to photograph the subject and send the radio signal from the mobile device to the flashgun based on the total flash light output required.

10. The flashgun of claim 8, wherein the application is configured to send the radio signal to a radio signal control system to adjust the sensitivity of the trigger device to operate the flash bulb when an audible event is detected by the microphone.

11. The flashgun of claim 8, wherein the application is configured to send the radio signal to a radio signal control system to adjust a period of time between the microphone detecting an audible event and the flash bulb being operated.

12. The flashgun of claim 8, wherein the application is further configured to use any of the occurrence sensors within the mobile device to detect an occurrence and to send a radio signal to the flashgun to operate the flash bulb.

13. The flashgun of claim 8, wherein the application is further configured to operate a mobile devices camera system to capture at least one image when the flashgun is operated during a second, photography, operational mode.

14. The flashgun of claim 8, where the application is further configured to operate a mobile devices camera system lo capture at least one image, when the flashgun according to any claims 2 to claim 4 is operated.

15. The flashgun of claim 8, wherein the application is further configured to operate a mobile devices camera system to capture a plurality of images and identify at least one image that was captured whilst the flashgun bulb was in operation.

16. The flashgun of claim 8, wherein the application is further configured to operate a mobile devices camera system to capture an image when a signal is received from the flashgun that the flash bulb has been triggered to operate.

17. The flashgun of claim 8, wherein the application is further configured to save only the at least one image that was captured whilst the bulb was in operation.

18. (canceled)

19. (canceled)

20. (canceled)
